(19) United States
(12) Patent Application Publication
(10) Pub. No.: US 2016/0286115 A1
(43) Pub. Date: Sep. 29, 2016

(54) FRONT FIELD OF VIEW CAMERA FOR MOBILE DEVICE

(71) Applicants: Mark M. Levy, Raanana (IL); Simon E. Levy, Raanana (IL)

(72) Inventors: Mark M. Levy, Raanana (IL); Simon E. Levy, Raanana (IL)

(21) Appl. No.: 14/665,230

(22) Filed: Mar. 23, 2015

(51) Int. Cl. H04N 5/232; G06F 1/16; H04N 5/225; G02B 27/01; H04N 7/18

(52) U.S. Cl. CPC H04N 5/23203; G02B 27/0172; H04N 7/185; H04N 5/2252; H04N 5/2254; G06F 1/163; H04N 5/23206; G02B 2027/0138

(57) ABSTRACT

A camera assembly includes a viewing device arranged to form images of a front field of view and means to transmit the images to a mobile device with a display. The viewing device displays images of the front field of view on a portion of the display. An alignment device aligns the viewing device to view the front field of view independent of the angular elevational position of the mobile device.

### CROSS-REFERENCE TO OTHER APPLICATIONS

This application claims priority from U.S. Provisional Patent Application 61/969192, filed Mar. 23, 2014.

### FIELD OF THE INVENTION

The present invention relates generally to mobile devices and particularly a camera for a screen of a mobile device that constantly photographs or films a field of view in front of the mobile device.

### BACKGROUND OF THE INVENTION

The use of smart-phones, mobile devices and electronic communication devices with a display or a screen is becoming extremely popular and even indispensable nowadays. For business, work, school or family and friends, social media, games, etc., almost everyone is using some kind of device with a display or screen. However, often the user is focused with his/her head tilted downwards looking at the screen of the mobile device and does not notice what is in front of him/her. This can lead to accidents, such as bumping into objects or people, or even worse, falling into pits, manholes and the like. Thus what is needed is an effective way to prevent such accidents and make use of the mobile device safer.

### SUMMARY OF THE INVENTION

The present invention seeks to provide a camera for a mobile device that constantly photographs or films a field of view in front of the mobile device, thereby solving the abovementioned problem of the prior art, as is described more in detail hereinbelow. The camera is pivoted or gimbaled to constantly look forward and the images viewed by the camera are displayed in a window on the screen of any mobile device.

There is thus provided in accordance with an embodiment of the present invention a camera assembly including means to transmit the images of a front field of view to a display of any mobile device, wherein the viewing device displays images of the front field of view on a portion of the display, and an alignment device that aligns the viewing device to view the front field of view independent of the angular elevational position of the mobile device or the position of the user's head (or the direction of the user's glance).

### BRIEF DESCRIPTION OF THE DRAWINGS

The present invention will be understood and appreciated more fully from the following detailed description, taken in conjunction with the drawing in which:

FIGS. 1 and 2 are simplified perspective illustrations of a camera assembly, constructed and operative in accordance with a non-limiting embodiment of the present invention.

### DETAILED DESCRIPTION OF EMBODIMENTS

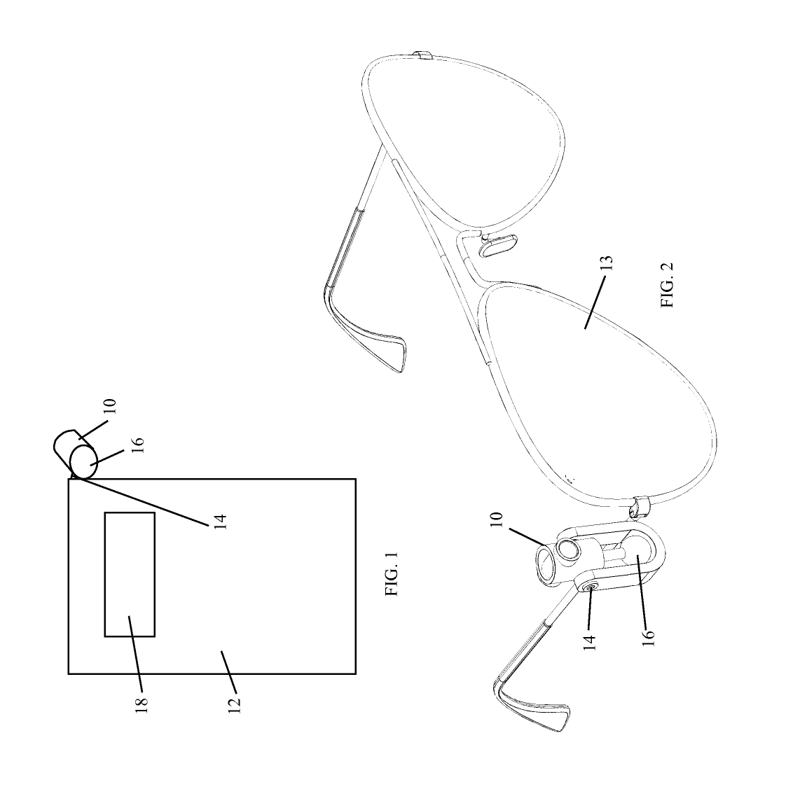

Reference is now made to FIGS. 1 and 2, which illustrate a camera assembly, constructed and operative in accordance with a non-limiting embodiment of the present invention.

A wearable or carried-on camera 10, webcam, lens of a camera or fiber optic tip (all referred to as a camera, viewing device or optic device) adjusts its position to steer to a given direction despite the movement of the user and displays the camera view on the display or screen 12 of an electronic device and catches the user's attention. The camera can be mounted in the side of a mobile device 12, the frame of glasses 13 (FIG. 2), such as optic glasses, sun glasses or blank glasses or even an empty frame, on goggles, on an ear piece holder, a headband, a necklace or even stick to the head or the face, on a hat, baseball cap, helmet or any other head appliance (attachment site). In addition, the camera can be mounted on a base with a sticker that can be temporarily attached to the skin or a cloth or accessory that the user is wearing. The optic device could have a wide angle lens or fish eye for wider coverage of the view in the same scope or a regular lens. The optic device 10 is mounted on a pivot 14, such as a pivot point, axis, bearing attachment, adjustable mechanism or any other dispositive that allows the free or needed movement or rotation of the device for self accommodation or adjustment to the given direction that can be chosen in advance. A counterbalance 16 (similar to a self-righting toy) in a given angle, preferable 90 degrees is advised if the camera should point ahead (to the front) at all times, but any angle can be used as well as a tolerance range for wider coverage. A ball or universal joint can also be used to connect the optic device to any attachment point. The adjustment process can be passive due to a counterbalance piece of weight or section of the device. A minor or array of minors, mounted at a fixed or variable angle, can be used to reflect the image to the camera. The minor or array of mirrors may include more than one view direction in order to capture the images to be sent to the display. Also a motorized or otherwise activated mechanism is incorporated in this disclosure, including electrically, magnetically or electro-magnetically activated, pneumatic or hydraulically activated. An inclinometer (liquid based or other) may be used for a two-degree of freedom alignment device, An accelerometer can also be adapted and used as a tilt sensor, A gyroscope assisted device can also be used for 3-dimentional adjustment if required. Another type of robotic-assisted device can be used as a programmable alignment device with two or three degrees of freedom. In one embodiment, the adjustment of the optic device can be programmed by the user, can be locked or unlocked in any position, can be disconnected and connected as required and can be switched to another mode like internet transmission, recording mode or any other combination.

The images produced by the optic device are to be projected on the screen 18, or a section of it, of the electronic device being used. Those include mobile phones, smart-phones, tablet screens, mobile computers, goggles, wrist or watches screens, instrument controls displays, multimedia screens, electronic game screen, screens of vehicle's dashboards or any other screens. It also can be projected on any extra or additional screen, on a glass mounted screen, a TV screen, a fixed screen or transmitted by internet or any other network. The images may be produced as analog signals and sent to the display or may be converted to digital signals by the addition of an electronic circuit or chip, to produce digital data to be sent to the display.

In another embodiment, the images are collected by a camera with a panoramic or wide angle lens or a parabolic lens. A full wide-angle image or a section of it can be selected to be sent to the display by digital processing of the data. More than one direction of the view can be captured and sent to the display if desired.

The transfer of the images from the optic device to the screen can be done via a cable or wire connected to the device. Also transfer wireless, via Bluetooth, RF, WiFi or any other mean suitable for wireless transmission is possible. A piece of software application may be needed in the electronic device or could be embedded in the hardware to be able to see the images of the optic device in the screen or part of it. The transfer of images can be continuous or discontinuous, in a regular or irregular pattern or following movement or any other given signal. The transfer of images can also be scattered in bursts of views for alerting the user and avoiding getting used to a monotonous flow of images. Software in a circuit or chip may be added to the digital images to define their flow to the display screen.

In one embodiment, the optic device and its wireless transmission can be activated by a small battery or a rechargeable unit. In a wired device, the power would come from the electronic device with the screen where the images are projected. The optic device can also be solar powered, piezoelectric powered or by movement charging tools attached to it. The batteries (and part or all the rest of the electronics) can be located in the counterweight piece, thereby minimizing the size of the device.

Audio can be incorporated to the optic device which can be heard by the used with earphones or speakers. In other embodiments, an acoustic accessory (e.g., sonar-like accessory) can be added to be able to locate the proximity to a solid body, like a wall or other then producing a visual alert on the screen like a flashing or blink image, with or without additional sound. Otherwise, movement sensors can also be included, alone or in addition to the previous one, to alert the user by a noise or signal of any movement ahead of the user. In another embodiment, the images can be processed to produce an alert sound when an object is in close proximity to the user.

The disclosed device can be used in other setups like in surgery, when using endoscopic surgery, arthroscopic surgery or other type of surgery when the surgeon looks at a display mounted up on the wall and not at the patient site. The device can be adjusted to look at the patient (usually down) at all times, despite the change of the glance of the surgeon but adjusting the image with the changes, and project the image in a corner or section of the screen or display for a constant view of the surgery site.

Other users that can take advantage of this device are pilots or motorcycle drivers that can have projected the images of an optic device mounted in their helmets or hats in a section of their glasses or visual aids, the controls displays, mobile phone screen or a combination of those. Car or other motor vehicles or machinery drivers, can also use the device, where the images of a wearable optic device are projected in a section of the multimedia screen of the vehicle, the controls display mobile phone screen, or a combination of those. In some cases, a fixed camera in the windshield may be used as well.

In the military, police or security forces, soldiers, and guards can use a wearable optic device to steer in a given direction where they are moving the glance to another, having projected the images in a section of wearable screen, special glasses or goggles, screen of operable machinery or transmission devices, keeping visual control of the situation at all times.

In another embodiment the field of view can be adjusted and changed to cover a different direction than the front view, as preferred, fixing the field of view to the new direction and sending the images to the display screen. If north is the chosen new direction, a compass or compass-like device can be used to make the camera orientation point always to the north. Another chosen direction could be the view of the ground at all times.

In another embodiment, two or more cameras can be used to provide images of two or more directions, such as, but not limited to, the front view and the ground view, the front view and the back view or any other combination displayed in two different sections or portions of the screen or a combination of a local display and a remote display, or even one local and another remote.

In another embodiment, the device can be used attached to smart goggles, already equipped with a fixed camera, like Google Glass or similar, where the device is constantly aligned to provide images of the front view, or any selected view direction chosen a priori, projected in a section of the glass.

The device can be connected to a portable smartphone or other device equipped with a software application and a GPS unit that provides a navigation system. Since the device always shows the front view, which in the case of a pedestrian or a motor vehicle includes the streets or field of view directions, the application can couple the directions of the GPS and the view and can draw arrows or other indicators on the display on the actual street or place in real time, displaying where to turn or continue the journey. Other software applications are suitable for virtual reality games or visual augmentation programs.

What is claimed is:

1. A camera assembly comprising:
a viewing device arranged to form images of a front field of view; and
means of transmitting the images to mobile device with a display, wherein said viewing device displays images of the front field of view on a portion of the display and an alignment device that aligns said viewing device to view the front field of view independent of the angular elevational position of the mobile device or the viewing device.

2. The camera assembly according to claim 1, wherein said alignment device comprises a pivotable counterweight.

3. The camera assembly according to claim 1, wherein said view direction is not a front view direction.

4. The camera assembly according to claim 1, wherein said images are transmitted to a screen of a fixed device or a fixed stand-alone screen.

5. The camera assembly according to claim 1, wherein said images are transmitted wirelessly to the screen.

6. The camera assembly according to claim 1, wherein said images are transmitted via wire or cables.

7. The camera assembly according to claim 1, wherein said images are accompanied by a sound signal coming from a sensor or acoustic device.

8. The camera assembly according to claim 1, further comprising an audible alert in the mobile device.

9. The camera assembly according to claim 1, wherein said alignment is done optically, mechanically, digitally or electronically alone or combined.

10. The camera assembly according to claim 1, wherein said images are transmitted in a continuous or discontinuous pattern.

11. The camera assembly according to claim 1, wherein said transmitted images are coupled to software applications in a mobile device.

12. The camera assembly according to claim 1, wherein said alignment device comprises a gyroscope.
